(19) United States
(12) Patent Application Publication
(10) Pub. No.: US 2021/0210789 A1
(43) Pub. Date: Jul. 8, 2021

(54) SECONDARY BATTERY

(71) Applicant: MURATA MANUFACTURING CO., LTD., Kyoto (JP)

(72) Inventors: Hiroshi HORIUCHI, Kyoto (JP); Nobuyuki IWANE, Kyoto (JP); Masayuki IHARA, Kyoto (JP)

(21) Appl. No.: 17/205,237

(22) Filed: Mar. 18, 2021

Related U.S. Application Data
(63) Continuation of application No. PCT/JP2019/036787, filed on Sep. 19, 2019.

(30) Foreign Application Priority Data
Sep. 19, 2018 (JP) 2018-175436

(51) Int. Cl. H01M 10/0585; H01M 10/46; H01M 4/66; H01M 4/62; H01M 10/0525; H02J 7/00

(52) U.S. Cl. CPC H01M 10/0585; H01M 10/46; H01M 4/661; H01M 2004/021; H01M 10/0525; H02J 7/0013; H01M 2220/30; H01M 4/623

(57) ABSTRACT

A secondary battery includes a plurality of positive electrodes having a positive electrode active material layer including a fluorine-based binder having a melting point of 166° C. or less, a plurality of negative electrodes having a negative electrode active material layer, and an electrolyte. The positive electrode active material layer and the negative electrode active material layer face each other and an edge of the positive electrode active material layer is located inside an edge of the negative electrode active material layer.

### CROSS REFERENCE TO RELATED APPLICATIONS

The present application is a continuation of PCT patent application no. PCT/JP2019/036787, filed on Sep. 19, 2019, which claims priority to Japanese patent application no. JP2018-175436 filed on Sep. 19, 2018, the entire contents of which are being incorporated herein by reference.

### BACKGROUND

The present technology generally relates to a secondary battery.

In recent years, a technology to use binders with low melting points as binders for electrodes has been investigated in order to improve battery characteristics.

### SUMMARY

The present technology generally relates to a secondary battery.

In recent years, secondary batteries have been used as a power source for various electronic devices and electric vehicles and cases where the secondary batteries are used in a high temperature environment have also increased. For this reason, it has become desirable to suppress a decrease in heating safety after charge and discharge cycles,

An object of the present technology is to provide a secondary battery capable of suppressing a decrease in heating safety after charge and discharge cycles.

According to an embodiment of the present disclosure a secondary battery is provided. The secondary battery includes a plurality of positive electrodes having a positive electrode active material layer including a fluorine-based binder having a melting point of 166° C. or less, a plurality of negative electrodes having a negative electrode active material layer, and an electrolyte. The positive electrode active material layer and the negative electrode active material layer face each other and an edge of the positive electrode active material layer is located inside an edge of the negative electrode active material layer.

According to the present technology, it is possible to suppress a decrease in heating safety after charge and discharge cycles. The effect described in the present disclosure is merely an example and is not restrictive, and an additional effect may be provided.

### BRIEF DESCRIPTION OF THE FIGURES

FIG. 1 is an exploded perspective view illustrating an example of the configuration of a non-aqueous electrolyte secondary battery according to an embodiment of the present technology.

FIG. 2 is a sectional view taken along the line II-II in FIG. 1.

FIG. 3 is a graph illustrating an example of a DSC curve of a fluorine-based binder according to an embodiment of the present technology.

FIG. 4 is a block diagram illustrating an example of the configuration of an electronic device according to an embodiment of the present technology.

### DETAILED DESCRIPTION

As described herein, the present disclosure will be described based on examples with reference to the drawings, but the present disclosure is not, to be considered limited to the examples, and various numerical values and materials in the examples are considered by way of example.

A wound type electrode body having a flat shape is fabricated by winding a positive electrode and a negative electrode around a flat core while turning these electrodes, and thus the positive electrode and the negative electrode have a steeply bent portion. In particular, on the inner peripheral side of the electrode body, the positive electrode and the negative electrode are bent by approximately 180 degrees and thus bending of the positive electrode and negative electrode becomes particularly steep. At such a place where the positive electrode and the negative electrode are steeply bent, the Li compound is likely to be deposited on the negative electrode as the charge and discharge cycle proceeds. Hence, in a secondary battery including a wound type electrode body having a flat shape, the heating safety decreases after the charge and discharge cycle.

On the other hand, in a laminate type electrode body in which a plurality of positive electrodes and a plurality of negative electrodes are alternately stacked, there is no place where the positive electrode and the negative electrode are steeply bent and it is thus possible to suppress the deposition of Li compound on the negative electrode.

However, in a laminate type electrode body, it is common to use a plurality of positive electrodes and a plurality of negative electrodes in order to achieve a desired energy density and desired input and output performance for a predetermined battery shape. Hence, the number of edges of positive electrode and negative electrode (namely, the total length of the edges of positive electrode and negative electrode) increases as compared with a wound type electrode body having a flat shape. Normally, the negative electrode active material layer is larger than the positive electrode active material layer, the edge of the positive electrode active material layer is located inside the edge of the negative electrode active material layer, and thus lithium ions released from the edge portion of the positive electrode active material layer are stored in the portion of the negative electrode active material layer facing the end portion of the positive electrode active material layer and then diffuse toward the edge portion of the negative electrode active material layer that does not face the positive electrode active material layer. The amount of lithium ions extracted from the edge portion of the positive electrode active material layer increases by this diffusion phenomenon when the charge and discharge cycle is repeated, and as a result, the potential at the edge portion of the positive electrode active material layer is higher than the potentials at portions other than the edge portion of the positive electrode active material layer at the time of charge. Hence, the laminate type electrode body has a larger number of places where the potential of the positive electrode is high as compared with a wound type electrode body having a flat shape

For this reason, in a laminate type electrode body, the heating safety after charge and discharge cycles decreases by a factor different from that in a wound type electrode body having a flat shape.

Accordingly, based on the above points, the present inventors have diligently studied a technique capable of suppressing a decrease in heating safety after a charge a discharge cycle in a secondary battery including a laminate type electrode body in which a plurality of positive electrodes and a plurality of negative electrodes are alternately stacked. As a result, it has been found out that when a fluorine-based hinder having a melting point of 166° C. or less is used as the binder for the positive electrode, the positive electrode active material particles can he favorably coated with the fluorine-based hinder, this makes it possible to suppress the progress of reaction between the positive electrode active material and the electrolytic solution at the edge portion of the positive electrode active material layer, and thus a decrease in heating safety after charge and discharge cycles can be suppressed even when the electrode body has a large number of places where the potential of the positive electrode is high.

The structure of electrode body greatly affects the phenomenon that the Li compound is deposited on the negative electrode at, the place where the positive electrode and the negative electrode are steeply bent. Hence, it is difficult to suppress the precipitation of Li compound even when a fluorine-based binder having a melting point of 166° C. or less is used. In other words, it is difficult to suppress a decrease in heating safety after charge and discharge cycles even when a fluorine-based binder having a melting point of 1.66° C. or less is applied to a wound type electrode body having a fiat shape.

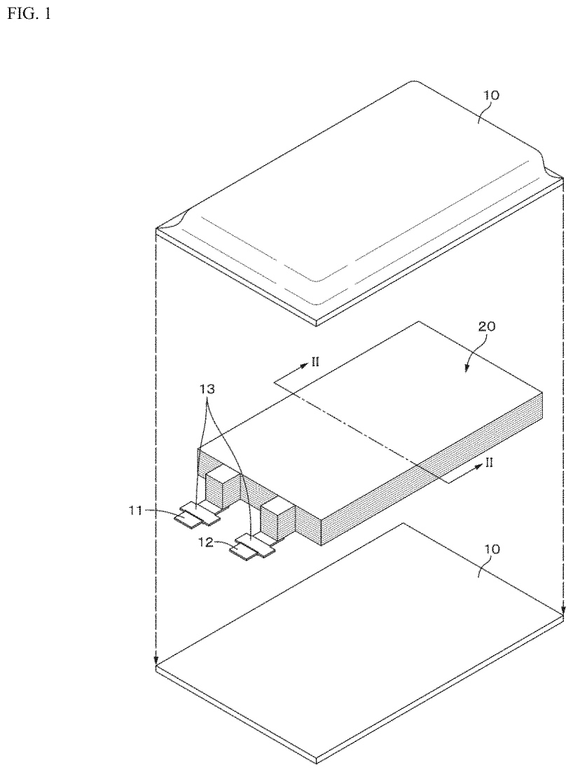

FIG. 1 illustrates an example of the configuration of a non-aqueous electrolyte secondary battery (hereinafter, simply referred to as “battery”) according to a first embodiment of the present technology. The battery is a so-called laminate type battery, an electrode body 20 to which a positive electrode lead 11 and a negative electrode lead 12 are attached is housed inside a film-like exterior material 10 in the battery, and miniaturization, weight saving, and thinning of the battery are possible.

The positive electrode lead 11 and the negative electrode lead 12 are both led out, for example, in the same direction from the inside to the outside of the exterior material 10. The positive electrode lead 11 and the negative electrode lead 12 are each formed of a metal material such as Al, Cu, Ni, or stainless steel and each have a thin plate shape or a mesh shape.

The exterior material 10 is formed of, for example, a rectangular aluminum laminate film in which a nylon film, an aluminum foil, and a polyethylene film are bonded to each other in this order. The exterior material 10 is arranged so that, for example, the polyethylene film side and the electrode body 20 face each other, and the respective outer edge portions are in close contact with each other by sealing or an adhesive. A close contact film 13 is inserted between the exterior material 10 and the positive electrode lead 11 and between the exterior material 10 and the negative electrode lead 12 in order to prevent intrusion of outside air. The close contact film 13 is formed of a material exhibiting close contact property to the positive electrode lead 11 and the negative electrode lead 12, for example, a polyolefin resin such as polyethylene, polypropylene, modified polyethylene, or modified polypropylene.

The exterior material 10 may be formed of a laminate film having another structure, a polymer film such as polypropylene, or a metal film instead of the above-described laminate film. Alternatively, the exterior material 10 may be formed of a laminate film in which a polymer film is laminated on one surface or both surfaces of an aluminum film as a core material.

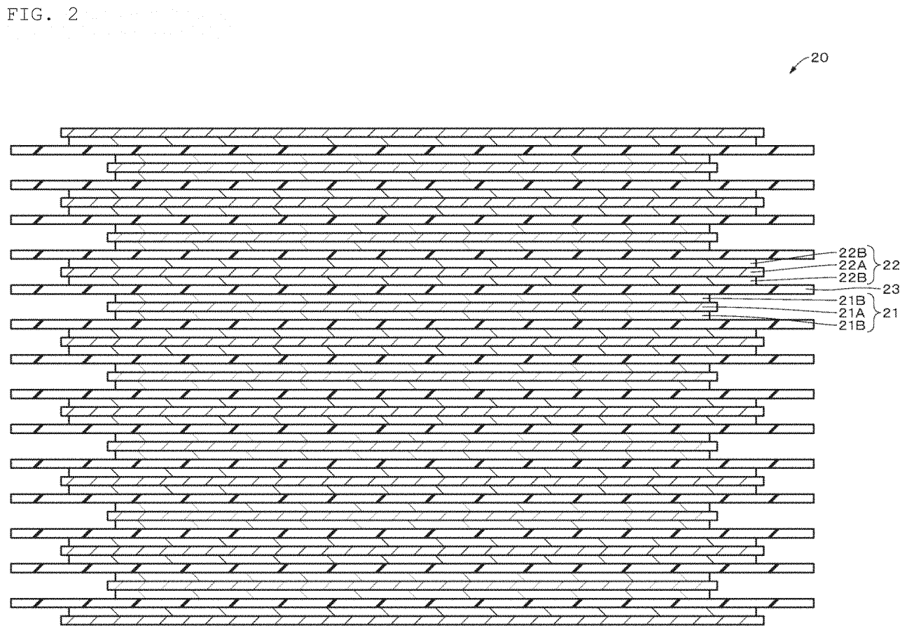

FIG. 2 is a sectional view of the electrode body 20 illustrated in FIG. 1 taken along the line II-II. The electrode body 20 includes a plurality of positive electrodes 21, a plurality of negative electrodes 22, a plurality of separators 23, and an electrolytic solution as an electrolyte and has a laminate type structure in which the positive electrodes 21 and the negative electrodes 22 are alternately stacked so as to sandwich the separators 23 therebetween. A battery having a relatively high volumetric energy density can be obtained by alternately stacking the positive electrodes 21 and the negative electrodes 22. This laminate type electrode body 20 does not have places where the positive electrodes 21 and the negative electrodes 22 are steeply bent and thus can suppress the deposition of Li compound on the negative electrodes 22 as compared with a wound type electrode body having a flat shape. The electrolytic solution is impregnated into the positive electrodes 21, the negative electrodes 22, and the separators 23.

Here, a configuration in which the electrode body 20 includes a plurality of separators 23 and these separators 23 are disposed between the positive electrodes 21 and the negative electrodes 22 is described, but the configuration of the electrode body 20 is not limited to this, and the electrode body 20 may have, for example, a configuration in which the electrode body 20 includes one sheet of separator 23 that is zigzag-folded and the positive electrodes 21 and the negative electrodes 22 are alternately disposed between the folded separator 23. A case in which the electrode body 20 is a laminate type is described, but the structure of the electrode body 20 is not limited to this, and the electrode body 20 may be, for example, a wound type electrode body having a columnar shape in which the positive electrode and the negative electrode are divided into two or more in the winding direction.

A case in which the positive electrode 21 and the negative electrode 22 have a planar shape is described, but the shapes of the positive electrode 21 and the negative electrode 22 are not limited to this, and the positive electrode 21 and the negative electrode 22 may have, for example, a bending shape such as a V-shape and a curved surface shape such as a curved shape. However, when the shapes of the positive electrode 21 and the negative electrode 22 are a bending shape, a steep bending shape having a bending angle of approximately 180 degrees is excluded. The bending angle is preferably more than 0 degrees and 135 degrees or less from the viewpoint of suppressing the deposition of Li compound on the negative electrode 22 at the bent portion. Here, a plane state in which the positive electrode 21 and the negative electrode 22 are not bent is defined as the reference (0 degree) of bending angle. The shapes of the positive electrode 21 and the negative electrode 22 are not limited to a rectangular shape and may be, for example, a circular shape, an elliptical shape, or a polygonal shape other than a rectangular shape.

Hereinafter, the positive electrode 21, the negative electrode 22, the separator 23, and the electrolytic solution which constitute the battery will be sequentially described.

The positive electrode 21 includes, for example, a positive electrode current collector 21A having a rectangular shape and a positive electrode active material layer 21B provided on both surfaces of the positive electrode current collector 21A. The positive electrode current collector 21A is formed of, for example, a metal foil such as an aluminum foil, a nickel foil, or a stainless foil. The positive electrode current collector 21A may have a plate shape or a mesh shape. The positive electrode current collector 21A has an extension portion in which a part of the peripheral edge of the positive electrode current collector 21A is extended. The positive electrode active material layer 21B is not provided at this extension portion, but the positive electrode current collector 21A is exposed at this extension portion. In a state in which the positive electrode 21 and the negative electrode 22 are piled up with the separator 23 sandwiched therebetween, a plurality of extension portions are joined to each other, and the positive electrode lead 11 is electrically connected to these joined extension portions. The positive electrode active material layer 21B contains one or two or more positive electrode active materials capable of storing and releasing lithium and a binder. The positive electrode active material layer 21B may further contain a conductive auxiliary if necessary.

As the positive electrode active material capable of storing and releasing lithium, a lithium-containing, compound, for example, lithium oxide, lithium phosphorus oxide, lithium sulfide, or an intercalation compound containing lithium is suitable, and two or more of these may be used in mixture. In order to increase the energy density, a lithium-containing compound which contains lithium, a transition metal element, and oxygen is preferable. Examples of such a lithium-containing compound include a lithium composite oxide having a layered rock salt type structure represented by Formula (A) and a lithium composite phosphate having an olivine type structure represented by Formula (B). The lithium-containing compound is more preferably one containing at least one selected from the group consisting of Co, Ni, Mn, and Fe as a transition metal element. Examples of such a lithium-containing compound include a lithium composite oxide having a layered rock salt type structure represented by Formula (C), Formula (D), or Formula (E), a lithium composite oxide having a spinel type structure represented by Formula (F), or a lithium composite phosphate having an olivine type structure represented by Formula (G), and specific examples thereof include LiNi_{0.50}Co_{0.20}Mn_{0.30}O₂, LiCoO₂, LiNiO₂, LiNiₐCo₁₋ₐO₂ (0<a<1), LiMn₂O₄, or LiFePO₄.

LiₚNi_{(1-q-r)}Mn_{q}M1ᵣO_{(2-y)}X_{z} (A)

(In Formula (A), M1 represents at least one selected from the elements belonging to the groups 2 to 15 except Ni and Mn. X represents at least one among the elements belonging to the group 16 and the elements belonging to the group 17 other than oxygen. p, q, y, and z are values within ranges of 0≤p≤1.5, 0≤q≤1.0, 0≤r≤1.0, −0.10≤y≤0.20, and 0≤z≤0.2.)

LiₐM2_{b}PO₄ (B)

(In Formula (B), M2 represents at least one selected from the elements belonging to the groups 2 to 15. a and b are values within ranges of 0≤a≤2.0 and 0.5≤b≤2.0.)

Li_{f}Mn_{(1-g-h)}Ni_{g}M3ₕO₍₂₋ⱼ₎Fₖ (C)

(In Formula (C), M3 represents at least one selected from the group consisting of Co, Mg, Al, B, Ti, V, Cr, Fe, Cu, Zn, Zr, Mo, Sn, Ca, Sr, and W. f, g, h, j, and k are values within ranges of 0.8≤f≤1.2, 0<g<0.5, 0≤h≤0.5, g+h<1, −0.1≤j≤0.2, and 0≤k≤0.1. The composition of lithium differs depending on the state of charge and discharge, and the value of f represents a value in the fully discharged state.)

LiₘNi₍₁₋ₙ₎M4ₙO₍₂₋ₚ₎F_{q} (D)

(In Formula (D), M4 represents at least one selected from the group consisting of Co, Mn, Mg, Al, Ti, V, Cr, Fe, Cu, Zn, Mo, Sn, Ca, Sr, and W. m, n, p, and q are values within ranges of 0.8≤m≤1.2, 0.005≤n≤0.5, −0.1≤p≤0.2, and 0≤q≤0.1. The composition of lithium differs depending on the state of charge and discharge, and the value of m represents a value in the fully discharged state.)

LiᵣCo₍₁₋ₛ₎M5ₛO₍₂₋ₜ₎Fᵤ (E)

(In Formula (E), M5 represents at least one selected from the group consisting of Ni, Mn, Mg, Al, B, Ti, V, Cr, Fe, Cu, Zn, Mo, Sn, Ca, Sr, and W. r, s, t, and u are values within ranges of 0.8≤r≤1.2, 0≤s<0.5, −0.1≤t≤0.2, and 0≤u≤0.1. The composition of lithium differs depending on the state of charge and discharge, and the value of r represents a value in the fully discharged state.)

LiᵥMn_{2-w}M6_{w}OₓF_{y} (F)

(In Formula (F), M6 represents at least one selected from the group consisting of Co, Ni, Mg, Al, B, Ti, V Cr, Fe, Cu, Zn, Mo, Sn, Ca, Sr, and W. v, w, x, and y are values within ranges of 0.9≤v≤1.1, 0≤w≤0.6, 3.7≤x≤4.1, and 0≤y≤0.1.

The composition of lithium differs depending on the state of charge and discharge, and the value of v represents a value in the folly discharged state.)

Li_{z}M7PO₄ (G)

(In Formula (G), M7 represents at least one selected from the group consisting of Co, Mg, Fe, Ni, Mg, Al, B, Ti, V, Nb, Cu, Zn, Mo, Ca, Sr, W, and Zr. z is a value within a range of 0.9≤z≤1.1. The composition of lithium differs depending on the state of charge and discharge, and ⁻the value of z represents a value in the fully discharged state.)

As the positive electrode active material capable of storing and releasing lithium, it is also possible to use inorganic compounds which do not contain lithium such as MnO₂, V₂O₅, V₆O₁₃, NiS, and MoS in addition to these.

The positive electrode active material capable of storing and releasing lithium may be one other than the above. Two or more of the positive electrode active materials exemplified above may be mixed in any combination.

The binder includes a fluorine-based binder. The upper limit value of the melting point of the fluorine-based binder is 166° C. or less, preferably 160° C. or less, more preferably 155° C. or less. When the melting point of the fluorine-based binder is 166° C. or less, the binder is easily melted when the positive electrode active material layer 21B is subjected to drying (heat treatment) in the process of fabricating the positive electrode 21, and the surface of the positive electrode active material particles can be favorably coated with a wide and thin binder film. For this reason, even when the potential at the edge portion of the positive electrode active material layer 21B has increased at the time of charge, it is possible to suppress the progress of reaction between the positive electrode active material and the electrolytic solution and the progress of deterioration in the positive electrode active material. Hence, it is possible to suppress a decrease in thermal safety of the positive electrode 21 after charge and discharge cycles even when the laminate type electrode body 20 has a larger number of places where the potential of the positive electrode 21 is high as compared with a wound type electrode body having a flat shape. Consequently, it is possible to suppress a decrease in heating safety of the battery after charge and discharge cycles. The lower limit value of the melting point of the fluorine-based binder is not particularly limited but is, for example, 152° C. or more.

The melting point of the fluorine-based binder is measured, for example, as follows. First, the positive electrode 21 is taken out from the battery, washed with dimethyl carbonate (DMC), and dried, then the positive electrode current collector 21A is removed therefrom, and the rest is heated and stirred in a proper dispersion medium (for example, N-methylpyrrolidone) to dissolve the binder, positive electrode active material and the like in the dispersion medium. Thereafter, the positive electrode active material is removed from the solution by centrifugation, and the remaining supernatant is filtered and then evaporated to dryness or the binder is reprecipitated by mixing the remaining supernatant with a solvent (for example, water) in which the binder does not dissolve. The binder can be thus taken out.

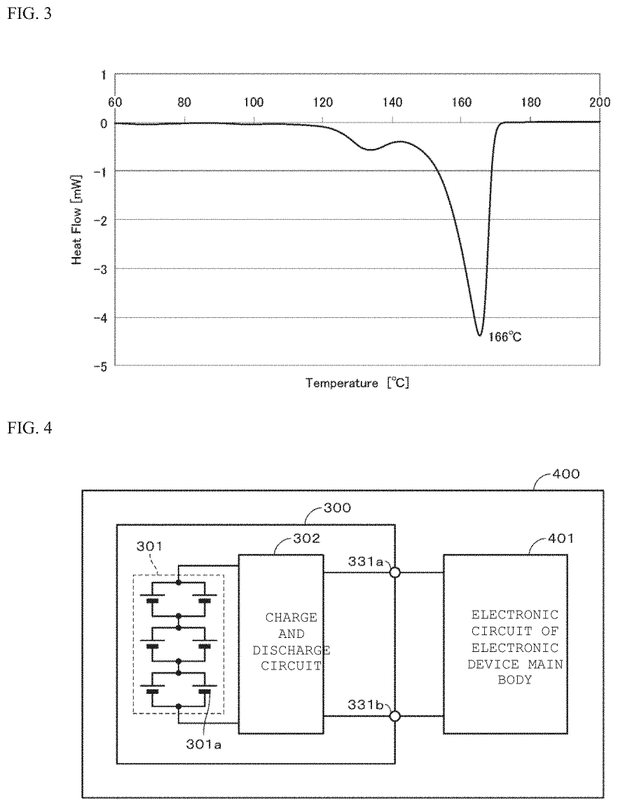

Next, a sample (binder taken out) in an amount of several to several tens of mg is heated at a rate of temperature rise of 1° C./min to 10° C./min using a differential scanning calorimeter (DSC, Rigaku Thermo plus DSC8230 manufactured by Rigaku Corporation), and the temperature at which the maximum endothermic energy amount is attained is taken as the melting point of the fluorine-based binder among the endothermic peaks (see FIG. 3) that appear in a temperature range of from 100° C. to 250° C. In the present technology, the temperature at which the polymer becomes fluid by heating and temperature rise is defined as the melting point.

The fluorine-based binder is, for example, polyvinylidene fluoride (PVH). As the polyvinylidene fluoride, it is preferable to use a homopolymer of vinylidene fluoride (VdF). As polyvinylidene fluoride, it is also possible to use a copolymer of vinylidene fluoride (VdF) with another monomer, but polyvinylidene fluoride that is a copolymer easily swells and dissolves in the electrolytic solution and has weak binding force, and thus the characteristics of the positive electrode 21 may decrease. As the polyvinylidene fluoride, one Obtained by modifying a part of its end and the like with a carboxylic acid such as maleic acid may be used.

The content of the fluorine-based binder in the positive electrode active material layer 21B is 0.5% by mass or more and 4.0% by mass or less, preferably 2.0% by mass or more and 4.0% by mass or less, more preferably 3.0% by mass or more and 4.0% by mass or less. When the content of the fluorine-based binder is 0.5% by mass or more, the surface of the positive electrode active material particles can be effectively coated with a. wide and thin binder film, and thus a decrease in thermal stability of the positive electrode 21 after charge and discharge cycles can be further suppressed. Hence, it is possible to suppress a decrease in heating safety of the battery after charge and discharge cycles. On the other hand, when the content of the fluorine-based binder is 4.0% by mass or less, particularly favorable charge and discharge cycle characteristics can be attained.

The content of the fluorine-based binder is measured as follows. First, the positive electrode 21 is taken out from the battery, washed with DMC, and dried. Next, a sample in an amount of several to several tens of mg is heated to 600° C. at a rate of temperature rise of 1° C./min to 5° C./min in an air atmosphere using a thermogravimetric-differential thermal analyzer (TG-DTA, Rigaku Thermo plus TG8120 manufactured by Rigaku Corporation), and the content of the fluorine-based binder in the positive electrode active material layer 21B is determined from the amount of weight reduction at that time. Whether or not the amount of weight reduction due to the binder can be confirmed by isolating the binder, performing TG-DTA measurement of only the binder in an air atmosphere, and examining at what temperature the binder burns as described in the method for measuring the melting point of the binder.

As the conductive auxiliary, for example, at least one carbon material among graphite, carbon fibers, carbon black, acetylene black, Ketjen black, carbon nanotubes, and graphene can be used. The conductive auxiliary may be any material exhibiting conductivity and is not limited to the carbon materials. For example, a metal material or a conductive polymer material may be used as the conductive auxiliary. Examples of the shape of the conductive auxiliary include a granular shape, a scaly shape, a hollow shape, a needle shape, and a tubular shape, but the shape is not limited to these shapes.

The content of the conductive auxiliary in the positive electrode active material layer 21B is preferably 0.3% by mass or more and 4.0% by mass or less. When the content of the conductive auxiliary is 0.3% by mass or more, a favorable conductive path can be secured in the positive electrode active material layer 21B, and thus the battery characteristics such as cycle characteristics and load characteristics can be further improved. On the other hand, when the content of the conductive auxiliary agent is 4.0% by mass or less, the amount of the binder adsorbed on the conductive auxiliary can be suppressed, and thus the positive electrode active material particles can be effectively coated with the binder. Hence, it is possible to further suppress a decrease in thermal stability of the positive electrode 21 after charge and discharge cycles. Consequently, it is possible to further suppress a decrease in heating safety of the battery after charge and discharge cycles.

The content of the conductive auxiliary is measured, for example, as follows. First, the positive electrode 21 is taken out from the battery, washed with DMC, and dried. Next, a sample in an amount of several to several tens of mg is heated to 600° C. at a rate of temperature rise of 1° C./min to 5° C./min in an air atmosphere using a thermogravimetric-differential thermal analyzer (TG-DTA, Rigaku Thermo plus TG8120 manufactured by Rigaku Corporation). Thereafter, the content of the conductive auxiliary is determined by subtracting the amount of weight reduction due to the combustion reaction of the binder from the amount of weight reduction at that time. Whether or not the amount of weight reduction due to the binder can be confirmed by isolating the binder, performing TG-DTA measurement of only the binder in an air atmosphere, and examining at what temperature the binder b iris as described in the method for measuring the melting point of the binder.

The negative electrode 22 includes, for example, a negative electrode current collector 22A having a rectangular shape and a negative electrode active material layer 22B provided on both surfaces of the negative electrode current collector 22A. The negative electrode current collector 22A is formed of, for example, a metal foil such as a copper foil, a nickel foil, or a stainless foil. The negative electrode current collector 22A may have a plate shape or a mesh shape. The negative electrode current collector 22A has an extension portion in which a part of the peripheral edge of the negative electrode current collector 22A is extended. The negative electrode active material layer 22B is not provided at this extension portion, but the negative electrode current collector 22A is exposed at this extension portion. In a state in which the positive electrode 21 and the negative electrode 22 are piled up with the separator 23 sandwiched therebetween, a plurality of extension portions are joined to each other, and the negative electrode lead 12 is electrically connected to these joined extension portions. The negative electrode active material layer 22B contains one or two or more negative electrode active materials capable of storing and releasing lithium. The negative electrode active material layer 22B may further contain at least one of a binder or a conductive auxiliary if necessary.

The negative electrode active material layer 22B is larger than the positive electrode active material layer 21B, and the edge of the positive electrode active material layer 21B is located inside the edge of the negative electrode active material layer 22B in a state in which the positive electrode 21 and the negative electrode 22 are piled up with the separator 23 sandwiched therebetween. More specifically, the relative positions of the positive electrode 21 and the negative electrode 22 are adjusted so that the projection surface of the positive electrode active material layer 21B fits inside the projection surface of the negative electrode active material layer 22B when viewed from the thickness direction (;stacking direction) of the laminate type electrode body 20.

When the edges of the negative electrode active material layer 22B and the positive electrode active material layer 21B are in the above positional relation, the potential at, the edge portion of the positive electrode active material layer 21B is higher than the potentials at portions other than the edge portion of the positive electrode active material layer 21B at the time of charge. In the battery according to the first embodiment, the positive electrode 21 contains a fluorine-based binder having a melting point of 166° C. or less, and thus the progress of reaction between the positive electrode active material and the electrolytic solution can be suppressed even when the potential at the edge portion of the positive electrode active material layer 21B has increased at the time of charge as described above. Hence, the progress of deterioration in the positive electrode active material can be suppressed.

Examples of the negative electrode active material include carbon materials such as non-graphitizable carbon, graphitizable carbon, graphite, pyrolytic carbons, cokes, glassy carbons, organic polymer compound fired bodies, carbon fibers, or activated carbon. Among these, the cokes include pitch coke, needle coke, petroleum coke or the like. The term “organic polymer compound fired bodies” refers to one obtained by tiring a polymer material such as phenol resin or furan resin at an appropriate temperature for carbonization, and some organic polymer compound fired bodies are classified as non-graphitizable carbon or graphitizable carbon. These carbon materials are preferable since the change in crystal structure that occurs at the time of charge and discharge is significantly small, a high charge and discharge capacity can be attained, and favorable cycle characteristics can. be attained. Particularly, graphite is preferable since graphite has a great electrochemical equivalent and a high energy density can be attained. Non-graphitizable carbon is preferable since excellent cycle characteristics can be attained.

Those having a low charge and discharge potential, specifically those having a charge and discharge potential close to that of lithium metal are preferable since it is possible to easily realize a high energy density of the battery,

Other negative electrode active materials capable of increasing the capacity also include materials containing at least one of a metal element or a metalloid element as a constituent element (for example, an alloy, a compound, or a mixture). This is because a high energy density can be attained when such a material is used. In particular, it is more preferable to use these materials together with the carbon materials since it is possible to attain a high energy density and excellent cycle characteristics. in the present technology, the alloy also includes alloys containing one or more metal elements and one or more metalloid elements in addition to alloys composed of two or more metal elements. The alloy may contain a nonmetallic element. The texture thereof includes a solid solution, a eutectic (eutectic mixture), an intermetallic compound, or coexistence of two or more thereof.

Examples of such a negative electrode active material include a metal element or metalloid element capable of forming an alloy with lithium. Specific examples thereof include Mg, B, Al, Ti, Ga, in, Si, Ge, Sn, Ph, Bi, Cd, Ag, Zn, Hf, Zr, Pd, or Pt. These may be crystalline or amorphous.

The negative electrode active material preferably contains a metal element or metalloid element of the group 4B in the short periodic table as a constituent element and more preferably contains at least either of Si or Sn as a constituent element. This is because Si and Sn have a great ability to store and release lithium and a high energy density can be attained. Examples of such a negative electrode active material include a simple substance, an alloy, or a compound of Si, and a simple substance, an alloy, or a compound of Sn, and materials haying one or two or more of these at least at a part.

Examples of Si alloys include those containing at least one selected from the group consisting of Sn, Ni, Cu, Fe, Co, Mn, Zn, In, Ag, Ti, Ge, Bi, Sb, Nb, Mo, P, Ga, and Cr as the second constituent element other than Si. Examples of Sn alloys include those containing at least one selected from the group consisting of Si, Ni, Cu, Fe, Co, Mn, Zn, In, Ag, Ti, Ge, Bi, Sb, Nb, Mo, Al, P, Ga, and Cr as the second constituent element other than Sn,

Examples of Sn compounds or Si compounds include those containing O or C as a constituent element. These compounds may contain the above-mentioned second constituent elements.

Among these, the Sn-based negative electrode active material preferably contains Co, Sn, and C as constituent elements and has a low crystalline or amorphous structure.

Examples of other negative electrode active materials also include metal oxides or polymer compounds capable of storing and releasing lithium. Examples of the metal oxides include lithium-titanium oxide containing Li and Ti such as lithium titanate (Li₄Ti₅O₁₂), iron oxide, ruthenium oxide, or molybdenum oxide. Examples of the polymer compounds include polyacetylene, polyaniline, or polypyrrole.

As the binder, for example, at least one selected from the group consisting of resin materials such as polyvinylidene fluoride (PVdF), polytetralluoroethylene (PTFE), polyacrylonitrile (PAN), styrene-butadiene rubber (SBR), carboxymethyl cellulose (CMC), and copolymers containing these resin materials as main components is used.

As the conductive auxiliary, conductive auxiliaries similar to those for the positive electrode active material layer 21B can be used.

The separator 23 separates the positive electrode 21 and the negative electrode 22 from each other, prevents short circuit of current due to the contact between both electrodes, and allows lithium ions to pass through. The separator 23 is formed of, for example, a porous film formed of polytetrafluoroethylene, a polyolefin resin (polypropylene (PP), polyethylene (PE) or the like), an acrylic resin, a styrene resin, a polyester resin, a nylon resin, or a resin obtained by blending these resins and may have a structure in which two or more of these porous films are laminated.

Among these, a polyolefin porous film is preferable since this has an excellent short circuit preventing effect and the safety of the battery can be improved by the shutdown effect. Particularly, polyethylene is preferable as a material forming the separator 23 since polyethylene is also excellent in electrochemical stability and a shutdown effect can be attained in a range of 100° C., or more and 160° C., or less. Among these, low-density polyethylene, high-density polyethylene, and linear polyethylene have proper melting temperatures, are easily procured, and thus are suitably used. In addition, a material obtained by copolymerizing or blending a resin exhibiting chemical stability with polyethylene or polypropylene can be used. Alternatively, the porous film may have a structure composed of three or more layers in which a polypropylene layer, a polyethylene layer, and a polypropylene layer are sequentially laminated. For example, it is desirable to have a three-layer structure of PP/PE/PP and

set the mass ratio [wt %] of PP to PE to PP:PE=60:40 to 75:25. Alternatively, a single-layer substrate formed of 100 wt % PP or 100 wt % PE can be used from the viewpoint of cost. The method for fabricating the separator 23 may be either of a wet method or a dry method.

A nonwoven fabric may be used as the separator 23. As the fibers constituting the nonwoven fabric, aramid fibers, glass fibers, polyolefin fibers, polyethylene terephthalate (PET) fibers, nylon fibers or the like can be used. A nonwoven fabric may be formed by mixing two or more of these fibers.

The separator 23 may have a configuration including a substrate and a surface layer provided on one surface or both surfaces of the substrate. The surface layer contains inorganic grains exhibiting electrical insulation property and a resin material which binds the inorganic grains to the surface of the substrate and the inorganic grains to each other. This resin material may be, for example, fibrillated and have a three-dimensional network structure in which a plurality of fibrils are linked to each other. The inorganic grains are supported on the resin material having this three-dimensional network structure.

The resin material may bind the surface of the substrate and the inorganic grains without being fibrillated. In this case, higher binding property can be attained. By providing the surface layer on one surface or both surfaces of the substrate as described above, the oxidation resistance, heat resistance, and mechanical strength of the separator 23 can be enhanced.

The substrate is a porous film which is permeable to lithium ions and is formed of an insulating film having a predetermined mechanical strength, and it is preferable that the substrate has characteristics to exhibit high resistance to the electrolytic solution, exhibit low reactivity, and hardly expand since the electrolytic solution is retained in the holes of the substrate.

As the material forming the substrate, the resin material or nonwoven fabric forming the above-described separator 23 can be used.

The inorganic grains contain at least one selected from the group consisting of a metal oxide, a metal nitride, a metal carbide, a metal sulfide and the like. As the metal oxide, it is possible to suitably use aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂), yttrium oxide (yttria, Y₂O₃) or the like. As the metal nitride, it is possible to suitably use silicon nitride (Si₃N₄), aluminum nitride (AlN), boron nitride (BN), titanium nitride (TiN) or the like. As the metal carbide, it is possible to suitably use silicon carbide (SiC), boron carbide (B₄C) or the like. As the metal sulfide, it is possible to suitably use barium sulfate (BaSO₄) or the like. Among the above-mentioned metal oxides, it is preferable to use alumina, titania (particularly those having a rutile type structure), silica, or magnesia and it is more preferable to use alumina.

The inorganic grains may contain minerals such as porous aluminosilicate such as zeolite (M_{2/n}O.Al₂O₃.xSiO₂.yH₂O, M is a metal element, x≥2, y≥0), layered silicate, barium titanate (BaTiO₃), or strontium titanate (SrTiO₃). The inorganic grains exhibit oxidation resistance and. heat resistance, and the surface layer of the positive electrode-facing side surface containing the inorganic grains exhibits strong resistance to the oxidizing environment in the vicinity of the positive electrode at the time of charge. The shape of the inorganic grains is not particularly limited, and any of spherical, plate-like, fibrous, cubic, or random-shaped inorganic grains can be used.

The grain size of the inorganic grains is preferably in a range of 1 nm or more and 10 μm or less. This is because it is difficult to procure the inorganic grains when the grain size is smaller than 1 nm and the distance between the electrodes is electrodes is far, the amount of active material filled in the limited spaces not sufficiently attained, and the battery capacity is low when the grain size is larger than 10 μm.

Examples of the resin material forming the surface layer include resins exhibiting high heat resistance as at least either of the melting point or the glass transition temperature thereof is 180° C. or more such as fluorine-containing resins such as polyvinylidene fluoride and polytetrafluoroethylene, fluorine-containing rubber such as vinylidene fluoride-tetrafluoroethylene copolymer and ethylene-tetrafluoroethylene copolymer, rubbers such as styrene-butadiene copolymer or hydrides thereof, acrylonitrile-butadiene copolymer or hydrides thereof, acrylonitrile-butadiene-styrene copolymer or hydrides thereof, methacrylic acid ester-acrylic acid ester copolymer, styrene-acrylic acid ester copolymer, acrylonitrile-acrylic acid ester copolymer, ethylene propylene rubber, polyvinyl alcohol, and polyvinyl acetate, cellulose derivatives such as ethyl cellulose, methyl cellulose, hydroxyethyl cellulose, and carboxymethyl cellulose, polyphenylene ether, polysulfone, polyether sulfone, polyphenylene sulfide, polyetherimide, polyimide, polyamide such as wholly aromatic polyamide (aramid), polyamide-imide, polyacrylonitrile, polyvinyl alcohol, polyether, an acrylic acid resin, or polyester. These resin materials may be used singly or in mixture of two or more thereof. Among these, a fluorine-based resin such as polyvinylidene fluoride is preferable from the viewpoint of oxidation resistance and flexibility and it is preferable to contain aramid or polyamide-imide from the viewpoint of heat resistance.

As the method for forming the surface layer, it is possible to use, for example, a method in which a slurry containing a matrix resin, a solvent, and inorganic grains is applied onto a substrate porous film) and the applied slurry is allowed to pass through a poor solvent of the matrix resin and a bath of a good solvent of the solvent for phase separation and then dried.

The above-described inorganic grains may be contained in the porous film as a substrate. The surface layer may not contain inorganic grains but may be formed only of a resin material.

The electrolytic solution is a so-called non-aqueous electrolytic solution and contains an organic solvent (non-aqueous solvent) and an electrolyte salt dissolved in this organic solvent. The electrolytic solution may contain a known additive in order to improve battery characteristics. An electrolyte layer containing an electrolytic solution and a polymer compound serving as a retainer for retaining this electrolytic solution may be used instead of the electrolytic solution. In this case, the electrolyte layer may be in a gel form.

As the organic solvent, a cyclic carbonic acid ester such as ethylene carbonate or propylene carbonate can be used, and it is preferable to use either of ethylene carbonate or propylene carbonate, particularly both of these in mixture. This is because cycle characteristics can be further improved.

As the organic solvent, it is preferable to use chain carbonic acid esters such as diethyl carbonate, dimethyl carbonate, ethyl methyl carbonate, or methyl propyl carbonate in mixture in addition to these cyclic carbonic acid esters. This is because high ionic conductivity can be attained.

It is preferable that the organic solvent further contains 2,4-difluoroanisole or vinylene carbonate. This is because 2,4-difluoroanisole can further improve the discharge capacity and vinylene carbonate can further improve the cycle characteristics. Hence, it is preferable to use these in mixture since the discharge capacity and the cycle characteristics can be further improved.

In addition to these, examples of the organic solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, N,N-dimethylimidazolidinone, nitromethane, nitroethane, sulfolane, dimethyl sulfoxide, or trimethyl phosphate.

A compound in which at least some of hydrogen atoms in these organic solvents are substituted with fluorine atoms may be preferable since this compound may be able to improve the reversibility of the electrode reaction depending on the kind of electrodes to be combined.

Examples of the electrolyte salt include a lithium salt, and one may be used singly or two or more may be used in mixture. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiCl, lithium difluoro[oxolato-O,O′]borate, lithium bisoxalate borate, or UBE Among these, LiPF₆ is preferable since high ionic conductivity can be attained and cycle characteristics can be further improved.

In the battery having the above-described configuration, when charge is performed, for example, lithium ions are released from the positive electrode active material layer 21B and stored in the negative electrode active material layer 22B via the electrolytic solution. When discharge is performed, for example, lithium ions are released from the negative electrode active material layer 22B and stored in the positive electrode active material layer 21B via the electrolytic solution.

Next, an example of the method for manufacturing the battery according to the first embodiment of the present technology will be described.

The positive electrode 21 is fabricated as follows. First, for example, a positive electrode active material, a binder, and a conductive auxiliary are mixed together to prepare a positive electrode mixture, and this positive electrode mixture is dispersed in a solvent such as N-methyl-2-pyrrolidone (NMP) to prepare a paste-like positive electrode mixture slurry. Next, this positive electrode mixture slurry is applied to the positive electrode current collector 21A, the solvent is dried, compression molding is performed using a roll pressing machine or the like to form the positive electrode active material layer 21B, and the positive electrode 21 is thus obtained. Finally, the positive electrode 21 is cut (slit) into a shape in which an extension portion (exposed portion of the positive electrode current collector 21A) is provided on one side of the rectangular shape to obtain a plurality of positive electrodes 21.

The negative electrode 22 is fabricated as follows. First, for example, a negative electrode active material and a binder are mixed together to prepare a negative electrode mixture, and this negative electrode mixture is dispersed in a solvent such as N-methyl-2-pyrrolidone to prepare a paste-like negative electrode mixture slurry.

Next, this negative electrode mixture slurry is applied to the negative electrode current collector 22A, the solvent is dried, compression molding is performed using a roll pressing machine or the like to form the negative electrode active material layer 22B, and the negative electrode 22 is thus obtained. Finally, the negative electrode 22 is cut (slit) into a shape in which an extension portion (exposed portion of the negative electrode current collector 22A) is provided on one side of the rectangular shape to obtain a plurality of negative electrodes 22.

The laminate type electrode body 20 is fabricated as follows. First, a plurality of separators 23 having a rectangular shape are prepared. Subsequently, the plurality of positive electrodes 21, the plurality of negative electrodes 22, and the plurality of separators 23 are piled up in the order of negative electrode 22, separator 23, positive electrode 21, separator 23, . . . , separator 23, positive electrode 21, separator 23, and negative electrode 21 to fabricate a laminate type electrode body 20. Next, the extension portions of the plurality of stacked positive electrodes 21 are joined to each other, and the positive electrode lead 11 is electrically connected to these joined extension portions. The extension portions of the plurality of stacked negative electrodes 22 are joined to each other, and the negative electrode lead 12 is electrically connected to these joined extension portions. Examples of the connection method include ultrasonic welding, resistance welding, and soldering, but it is preferable to use a method having less heat affect such as ultrasonic welding or resistance welding in consideration of damage to the connection portion due to heat.

The electrode body 20 is sealed with the exterior material 10 as follows. First, the electrode body 20 is sandwiched between the exterior materials 10, the outer peripheral edge portions excluding that of one side are heat-sealed to form a bag shape, and the electrode body 20 is thus housed inside the exterior material 10. At that time, the close contact film 13 is inserted between the positive electrode lead 11 and the exterior material 10 and between the negative electrode lead 12 and the exterior material 10. The close contact film 13 may be attached to each of the positive electrode lead 11 and the negative electrode lead 12 in advance.

Next, the electrolytic solution is injected into the exterior material 10 through the unfused one side, and then the unfused one side is heat-sealed in a vacuum atmosphere for hermetic seal, The battery illustrated in FIGS. 1 and 2 is thus obtained.

In the battery according to the first embodiment, the laminate type electrode body 20 in which the plurality of positive electrodes 21 and the plurality of negative electrodes 22 are alternately piled up so as to sandwich the separators 23 therebetween is combined with the positive electrode active material layer 21B containing a fluorine-based binder having a melting point of 166° C. or less. This makes it possible to suppress the deposition of Li compound on the negative electrode as compared with a wound type electrode body having a flat shape.

The positive electrode active material particles can be favorably coated with the fluorine-based binder, and it is thus possible to suppress the progress of reaction between the positive electrode active material and the electrolytic solution, namely, the progress of deterioration in the positive electrode active material even when the potential at the edge portion of the positive electrode active material layer 21B has increased at the time of charge. Consequently, it is possible to suppress not only a decrease in heating safety of the battery before charge and discharge cycles but also a decrease in heating safety of the battery after charge and discharge cycles. It is also possible to attain favorable cycle characteristics.

In a second embodiment, an electronic device including the battery according to the first embodiment described above will be described.

FIG. 4 illustrates an example of the configuration of an electronic device 400 according to the second embodiment of the present technology. The electronic device 400 includes an electronic circuit 401 of the electronic device main body and the battery pack 300. The battery pack 300 is electrically connected to the electronic circuit 401 via a positive electrode terminal 331a and a negative electrode terminal 331b. The electronic device 400 has, for example, a configuration in which the battery pack 300 is freely attached and detached.

Examples of the electronic device 400 include laptop personal computers, tablet computers, mobile phones (for example, smartphones), personal digital assistants (PDA), display devices (Liquid Crystal Display (LCD), Electro Luminescence (EL) display, electronic paper and the like), imaging devices (for example, digital still cameras, digital video cameras and the like), audio devices (for example, portable audio players), game consoles, cordless phones, electronic books, electronic dictionaries, radios, headphones, navigation systems, memory cards, pacemakers, hearing aids, electric power tools, electric shavers, refrigerators, air conditioners, TVs, stereos, water heaters, microwave ovens, dishwashers, washing machines, dryers, lighting equipment, toys, medical equipment, robots, road conditioners, and traffic lights, but the electronic device 400 is not limited thereto.

The electronic circuit 401 includes, for example, a Central Processing Unit (CPU)or a processor, a peripheral logic unit, an interface unit, a storage unit, and the like and controls the entire electronic device 400.

The battery pack 300 includes an assembled battery 301 and a charge and discharge circuit 302. The battery pack 300 may further include an exterior material (not illustrated) which houses the assembled battery 301 and the charge and discharge circuit 302, if necessary.

The assembled battery 301 is configured by connecting a plurality of secondary batteries 301a in series and/or in parallel. The plurality of secondary batteries 301a are connected, for example, n in parallel and m in series (n and m are positive integers). FIG. 4 illustrates an example in which six secondary batteries 301a are connected in the form of two in parallel-33 three in series (2P3S). As the secondary battery 301a, the battery according to the first embodiment described above is used.

Here, a case in which the battery pack 300 includes the assembled battery 301 including the plurality of secondary batteries 301a is described, but a configuration in which the battery pack 300 includes one secondary battery 301a instead of the assembled battery 301 may be adopted.

The charge and discharge circuit 302 is a control unit which controls charge and discharge of the assembled battery 301. Specifically, the charge and discharge circuit 302 controls charge of the assembled battery 301 at the time of charge. On the other hand, the charge and discharge circuit 302 controls discharge of the electronic device 400 at the time of discharge (that is, when the electronic device 400 is used).

As the exterior material, for example, a case formed of a metal, a polymer resin, or a composite material thereof can be used. Examples of the composite material include a laminated body in which a metal layer and a polymer resin layer are laminated.

Hereinafter, the present technology will be specifically described with reference to Examples, but the present technology is not limited only to these Examples.

The melting points of the fluorine-based binders in the following Examples and Comparative Examples are determined by the measuring method described in the first embodiment described above.

### EXAMPLE 1-1

The positive electrode was fabricated as follows. First, a positive electrode mixture was Obtained by mixing 99.2% by mass of lithium-cobalt composite oxide (LiCoO₂) as a positive electrode active material, 0.5% by mass of polyvinylidene fluoride (PVdF (homopolyiner of vinylidene fluoride)) having a melting point of 155° C. as a binder, and 0.3% by mass of carbon nanotubes as a conductive agent, and then this positive electrode mixture was dispersed in an organic solvent (N-methyl-2-pyrrolidone: NMP) to obtain a paste-like positive electrode mixture slurry. Subsequently, the positive electrode current collector (aluminum foil) was coated with the positive electrode mixture slurry using a coating apparatus and then dried to form a positive electrode active material layer. Next, the positive electrode active material layer was compression-molded using a pressing machine to obtain a positive electrode. Finally, the positive electrode was cut (slit) into a shape in which an extension portion (exposed portion of the positive electrode current collector) was provided on one side of the rectangular shape to obtain a plurality of positive electrodes.

The negative electrode was fabricated as follows. First, a negative electrode mixture was obtained by mixing 96% by mass of artificial graphite powder as a negative electrode active material, 1% by mass of styrene-butadiene rubber (SBR) as a first binder, 2% by mass of polyvinylidene fluoride (PVdF) as a second binder, and 1% by mass of carboxymethyl cellulose (CMC) as a thickener, and then this negative electrode mixture was dispersed in a solvent to obtain a paste-like negative electrode mixture slurry. Subsequently, the negative electrode current collector (copper foil) was coated with the negative electrode mixture slurry using a coating apparatus and then dried. Next, the negative electrode active material layer was compression-molded using a pressing machine to obtain a negative electrode. Finally, the negative electrode was cut (slit) into a shape in which an extension portion (exposed portion of the negative electrode current collector) was provided on one side of the rectangular shape to obtain a plurality of negative electrodes.

The electrolytic solution was prepared as follows. First, ethylene carbonate (EC), propylene carbonate (PC), and diethyl carbonate (DEC) were mixed together at a mass ratio of EC:PC:DEC=15:15:70 to prepare a mixed solvent. Subsequently, an electrolytic solution was prepared by dissolving lithium hexafluorophosphate (LiPF₆) as an electrolyte salt in this mixed solvent so as to have a concentration of 1 mol/l.

A laminate type battery was fabricated as follows. First, a PVdF layer was formed on both surfaces of the plurality of positive electrodes obtained as described above and both surfaces of the plurality of negative electrodes obtained as described above. Subsequently, a plurality of microporous polyethylene films having a rectangular shape were prepared as a separator, and the positive electrode, the separator, the negative electrode, and the separator were repeatedly piled up in this order to obtain a laminate type electrode body. In this piling up, the relative positions of the negative electrode and the positive electrode were adjusted so that the projection surface of the positive electrode active material layer fit inside the projection surface of the negative electrode active material layer when viewed from the thickness direction (stacking direction) of the electrode body.

Next, the extension portion of the positive electrode was ultrasonically welded to the aluminum positive electrode lead at the same time. Similarly, the extension portion of the negative electrode was ultrasonically welded to the nickel negative electrode lead at the same time. Next, the laminate type electrode body was exteriorized by folding a rectangular exterior material having a soft aluminum layer, the lead-out side of the positive electrode lead and the negative electrode lead in the vicinity of the laminate type electrode body and one side on one side side (long side side) were heat-sealed for sealing, and one side of the other side side (long side side) was not heat-sealed but had an opening. As the exterior material, a moistureproof aluminum laminate film in which a 25 μm thick nylon film, a 40 μm thick aluminum foil, and a 30 μm thick polypropylene film were laminated in this order from the outermost layer was used.

Thereafter, the electrolytic solution was injected through the opening of the exterior material, and the remaining one side of the exterior material was heat-sealed under reduced pressure to hermetically seal the laminate type electrode body. The intended laminate type battery was thus obtained. This laminate type battery is designed so that the open circuit voltage (namely, battery voltage) at full charge is 4.45 V by adjusting the amount of positive electrode active material and the amount of negative electrode active material.

### EXAMPLES 1-2 TO 1-8

As shown in FIG. 1, Laminate type batteries were obtained in the same manner as in Example 1-1 except that a positive electrode mixture was obtained by mixing 98.8% to 90.0% by mass of lithium-cobalt composite oxide (LiCoO₂) as a positive electrode active material, 0.7% to 5.0% by mass of polyvinylidene fluoride (PVdF) having a melting point of 155° C. as a binder, and 0.5% to 5.0% by mass of carbon black as a conductive agent.

### COMPARATIVE EXAMPLE 1-1

A positive electrode was fabricated in the same manner as in Example 1-1, and then the positive electrode was cut (slit) into a band shape to obtain a positive electrode in which an exposed portion of positive electrode current collector was provided at both ends longitudinal direction.

A negative electrode was fabricated in the same manner as in Example 1-1, and then the negative electrode was cut (slit) into a band shape to obtain a negative electrode in which an exposed portion of negative electrode current collector was provided at both ends in the longitudinal direction.

An electrolytic solution was prepared in the same manner as in Example 1-1.

A laminate type battery was fabricated as follows. First, an aluminum positive electrode lead was welded to the exposed portion of positive electrode current collector provided at one end of the positive electrode and a copper negative electrode lead was welded to the exposed portion of negative electrode current collector provided at one end of the negative electrode. Subsequently, a microporous polyethylene film having a band shape was prepared as a separator, and both surfaces of this separator was coated with a fluororesin (vinylidene fluoride-hexafluoropropylene copolymer (VDF-HFP copolymer)). Next, the positive electrode and negative electrode which were obtained as described above were brought into close contact with each other with the separator interposed therebetween and then wound in the longitudinal direction, and a protective tape was attached to the outermost peripheral portion to obtain a wound type electrode body having a flat shape. At this time, a structure (foil-foil facing structure) in which the exposed portion of positive electrode current collector and the exposed portion of negative electrode current collector faced each other with the separator interposed therebetween was formed on the outer peripheral portion of the electrode body and the positive electrode and the negative electrode were wound so that the positive electrode lead and the negative electrode lead were pulled out from the inner peripheral side of the electrode body. Next, the wound type electrode body was hermetically sealed with a rectangular exterior material having a soft aluminum layer in the same manner as in Example 1-1. The intended laminate type battery was thus obtained.

### COMPARATIVE EXAMPLES 1-2 TO 1-6

Laminate type batteries were obtained in the same manner as in Comparative Example 1-1 except that positive electrodes were fabricated in the same manner as in Examples 1-2 to 1-6 and then the positive electrodes were cut (slit) into a band shape to obtain positive electrodes in which an exposed portion of positive electrode current collector was provided at both ends in the longitudinal direction. However, in Comparative Examples 1-5 and 1-6 in which the positive electrode binder was 4.0% by mass or more, the positive electrodes were hard, the positive electrodes cracked at the time of winding, and thus the batteries were not able to be fabricated.

### EXAMPLES 2-1 TO 2-8

Laminate type batteries were obtained in the same manner as in Examples 1-1 to 1-8 except that polyvinylidene fluoride (PVdF) having a melting point of 166° C. was used as a. binder.

### COMPARATIVE EXAMPLES 2-1 TO 2-6

Laminate type batteries were obtained in the same manner as in Comparative Examples 1-1 to 1-6 except that polyvinylidene fluoride (PVdF) having a melting point of 166° C. was used as a binder. However, in Comparative Examples 2-5 and 2-6 in which the positive electrode binder was 4.0% by mass or more, the positive electrodes were hard, the positive electrodes cracked at the time of winding, and thus the batteries were not able to be fabricated.

### COMPARATIVE EXAMPLES 31 TO 3-8

Laminate type batteries were obtained in the same manner as in Examples 1-1 to 1-8 except that polyvinylidene fluoride (PVdF) having a melting point of 172° C. was used as a binder.

### COMPARTATIVE EXAMPLES 4-1 TO 4-6

Laminate type batteries were obtained in the same manner as in Comparative Examples 1-1 to 1-6 except that polyvinylidene fluoride (PVdF) having a melting point of 172° C. was used as a binder. However, in Comparative Examples 4-5 and 4-6 in which the positive electrode binder was 4.0% by mass or more, the positive electrodes were hard, the positive electrodes cracked at the time of winding, and thus the batteries were not able to be fabricated.

The laminate type batteries obtained as described above were subjected to charge and discharge cycles test, a heating safety test before and after charge and discharge cycles, and the evaluation on positive electrode cracking as follows.

First, the battery was charged at constant current and constant voltage (CCCV charge) up to 4.45 V that was the designed full charge voltage. The constant current value was 1 ItA, and the charge end condition was 0.02 ItA. Next, the battery was discharged at 1 ItA until to reach 3 V by constant current discharge (CC discharge), and this was defined as one cycle. Charge and discharge were performed 1000 cycles under the above conditions, and the capacity retention after 1000 cycles was determined by taking the discharge capacity in the first cycle as 100%.

### (Heating Safety Test Before Charge and Discharge Cycle)

The battery was fully charged, then the temperature was raised to 140° C. at 5° C./min, and the battery was held at this temperature for 1 hour to examine the presence or absence of thermal runaway of the battery.

### (Heating Test After Charge and Discharge Cycle)

First, charge and discharge were performed 1000 cycles in the same manner as in the charge and discharge cycle test. Subsequently, the presence or absence of thermal runaway of the battery was examined in the same manner as in the heating safety test before charge and discharge cycles.

The wound battery was disassembled, and it was examined whether or not a hole was formed in the positive electrode current collector at the innermost peripheral portion.

Table 1 presents the configurations and evaluation results of the laminate type batteries in Examples 1-1 to 1-8 and Comparative Examples 1-1 and 1-6.

TABLE 1

| | | | | | Presence or | | | |
|---|---|---|---|---|---|---|---|---|
| | | | | | absence of | | | Presence |
| | | | | | thermal | | | or |
| | | | | | runaway in | | | absence |
| | | Binder | | Conductive | heating test | | | of |
| | Electrode | melting | Binder | agent | | After | Cycle | positive |
| | body | point | content | content | Before | 1000 | characteristic | electrode |
| | configuration | [° C.] | [% by mass] | [% by mass] | cycle | cycles | [%] | cracking |
| Example 1-1 | Laminate | 155 | 0.5 | 0.3 | Absence | Absence | 81 | Absence |
| Example 1-2 | type | | 0.7 | 0.5 | Absence | Absence | 85 | Absence |
| Example 1-3 | | | 1.4 | 1.5 | Absence | Absence | 86 | Absence |
| Example 1-4 | | | 2.8 | 2.8 | Absence | Absence | 88 | Absence |
| Example 1-5 | | | 4.0 | 4.0 | Absence | Absence | 84 | Absence |
| Example 1-6 | | | 5.0 | 5.0 | Absence | Absence | 78 | Absence |
| Example 1-7 | | | 4.0 | 2.0 | Absence | Absence | 82 | Absence |
| Example 1-8 | | | 1.4 | 2.8 | Absence | Absence | 87 | Absence |
| Comparative | Wound | 155 | 0.5 | 0.3 | Absence | Presence | 60 | Absence |
| Example 1-1 | type | | | | | | | |
| Comparative | | | 0.7 | 0.5 | Absence | Presence | 65 | Absence |
| Example 1-2 | | | | | | | | |
| Comparative | | | 1.4 | 1.5 | Absence | Presence | 68 | Absence |
| Example 1-3 | | | | | | | | |
| Comparative | | | 2.8 | 2.8 | Absence | Presence | 66 | Absence |
| Example 1-4 | | | | | | | | |

| | | | | |
|---|---|---|---|---|
| Comparative | 4.0 | 4.0 | Battery is not completed | Presence |
| Example 1-5 | | | | |
| Comparative | 5.0 | 5.0 | Battery is not completed | Presence |
| Example 1-6 | | | | |

Table 2 presents the configurations and evaluation results of the laminate type batteries in Examples 2-1 to 2-8 and Comparative Examples 2-1 and 2-6.

TABLE 2

| | | | | | Presence or | | | |
|---|---|---|---|---|---|---|---|---|
| | | | | | absence of | | | Presence |
| | | | | | thermal | | | or |
| | | | | | runaway in | | | absence |
| | | Binder | | Conductive | heating test | | | of |
| | Electrode | melting | Binder | agent | | After | Cycle | positive |
| | body | point | content | content | Before | 1000 | characteristic | electrode |
| | configuration | [° C.] | [% by mass] | [% by mass] | cycle | cycles | [%] | cracking |
| Example 2-1 | Laminate | 166 | 0.5 | 0.3 | Absence | Absence | 80 | Absence |
| Example 2-2 | type | | 0.7 | 0.5 | Absence | Absence | 83 | Absence |
| Example 2-3 | | | 1.4 | 1.5 | Absence | Absence | 85 | Absence |
| Example 2-4 | | | 2.8 | 2.8 | Absence | Absence | 86 | Absence |
| Example 2-5 | | | 4.0 | 4.0 | Absence | Absence | 82 | Absence |
| Example 1-6 | | | 5.0 | 5.0 | Absence | Absence | 76 | Absence |
| Example 2-7 | | | 4.0 | 2.0 | Absence | Absence | 81 | Absence |
| Example 2-8 | | | 1.4 | 2.8 | Absence | Absence | 85 | Absence |
| Comparative | Wound | 166 | 0.5 | 0.3 | Absence | Presence | 58 | Absence |
| Example 2-1 | type | | | | | | | |
| Comparative | | | 0.7 | 0.5 | Absence | Presence | 63 | Absence |
| Example 2-2 | | | | | | | | |
| Comparative | | | 1.4 | 1.5 | Absence | Presence | 66 | Absence |
| Example 2-3 | | | | | | | | |
| Comparative | | | 2.8 | 2.8 | Absence | Presence | 62 | Absence |
| Example 2-4 | | | | | | | | |

| | | | | |
|---|---|---|---|---|
| Comparative | 4.0 | 4.0 | Battery is not completed | Presence |
| Example 2-5 | | | | |
| Comparative | 5.0 | 5.0 | Battery is not completed | Presence |
| Example 2-6 | | | | |

Table 3 presents the configurations and evaluation results of the laminate type batteries in Comparative Examples 3-1 to 3-8 and Comparative Examples 4-1 and 4-6.

TABLE 3

| | | | | | Presence or | | | |
|---|---|---|---|---|---|---|---|---|
| | | | | | absence of | | | Presence |
| | | | | | thermal | | | or |
| | | | | | runaway in | | | absence |
| | | Binder | | Conductive | heating test | | | of |
| | Electrode | melting | Binder | agent | | After | Cycle | positive |
| | body | point | content | content | Before | 1000 | characteristic | electrode |
| | configuration | [° C.] | [% by mass] | [% by mass] | cycle | cycles | [%] | cracking |
| Comparative | Laminate | 172 | 0.5 | 0.3 | Presence | Presence | 55 | Absence |
| Example 3-1 | type | | | | | | | |
| Comparative | | | 0.7 | 0.5 | Presence | Presence | 61 | Absence |
| Example 3-2 | | | | | | | | |
| Comparative | | | 1.4 | 1.5 | Presence | Presence | 65 | Absence |
| Example 3-3 | | | | | | | | |
| Comparative | | | 2.8 | 2.8 | Presence | Presence | 67 | Absence |
| Example 3-4 | | | | | | | | |
| Comparative | | | 4.0 | 4.0 | Presence | Presence | 61 | Absence |
| Example 3-5 | | | | | | | | |
| Comparative | | | 5.0 | 5.0 | Presence | Presence | 60 | Absence |
| Example 3-6 | | | | | | | | |
| Comparative | | | 4.0 | 2.0 | Presence | Presence | 59 | Absence |
| Example 3-7 | | | | | | | | |
| Comparative | | | 1.4 | 2.8 | Presence | Presence | 66 | Absence |
| Example 3-8 | | | | | | | | |
| Comparative | Wound | 172 | 0.5 | 0.3 | Presence | Presence | 48 | Absence |
| Example 4-1 | type | | | | | | | |
| Comparative | | | 0.7 | 0.5 | Presence | Presence | 54 | Absence |
| Example 4-2 | | | | | | | | |
| Comparative | | | 1.4 | 1.5 | Presence | Presence | 58 | Absence |
| Example 4-3 | | | | | | | | |
| Comparative | | | 2 8 | 2.8 | Presence | Presence | 54 | Absence |
| Example 4-4 | | | | | | | | |

| | | | | |
|---|---|---|---|---|
| Comparative | 4.0 | 4.0 | Battery is not completed | Presence |
| Example 4-5 | | | | |
| Comparative | 5.0 | 5.0 | Battery is not completed | Presence |
| Example 4-6 | | | | |

The following can be seen when the evaluation results in Examples 1-1 to 1-8, Examples 2-1. to 2-8, and Comparative Examples 3-1 to 3-8 are compared with one another.

In a laminate type battery including a laminate type electrode body, hen the melting point of the positive electrode binder is 166° C. or less, it is possible to attain favorable charge and discharge cycle characteristics (charge and discharge cycle characteristic of 70% or more) and suppress the occurrence of thermal runaway in the heating safety test before and after charge and discharge cycles. When the positive electrode binder content is 4.0% or less, particularly favorable charge and discharge characteristics (charge and discharge cycle characteristic of 80% or more) can be attained.

In contrast, in a laminate type battery including a laminate type electrode body, when the melting point of the positive electrode binder exceeds 166° C., not only the charge and discharge cycle characteristics decrease but also thermal runaway cannot be suppressed in the heating test before and after charge and discharge cycles.

The factor of a decrease in charge and discharge cycle characteristics observed when the positive electrode binder content exceeds 4.0% is considered to be the following points. In other words, as the binder ratio in the positive electrode active material layer increases, the internal resistance of the battery increases, and the temperature of the battery increases by Joule heat generation (self-heating) at the time of charge and discharge. As a result, the battery is in the charge and discharge situation in a high temperature environment, and the positive electrode active material reacts with the electrolytic solution, and thus the cycle characteristics are considered to decrease.

The following can be seen when the evaluation results in Comparative Examples 1-1 to 1-6, Comparative Examples 2-1 to 2-6, and Comparative Examples 4-1 to 4-6 are compared with one another.

In a laminate type battery including a wound type electrode body having a flat shape, the charge and discharge cycle characteristics decrease even when the melting point of the positive electrode binder is 166° C. or less. The occurrence of thermal runaway can be suppressed in the heating test before charge and discharge cycles, but the thermal runaway cannot be suppressed in the heating test after charge and discharge cycles.

In contrast, in a laminate type battery including a laminate type electrode body having a flat shape, when the melting point of the positive electrode binder exceeds 166° C., not only the charge and discharge cycle characteristics decrease but also thermal runaway cannot be suppressed in the heating test before and after charge and discharge cycles in the same manner as in a laminate type battery including a laminate type electrode body.

In Comparative Examples 1-5, 1-6, 2-5, 2-6, 4-5, and 4-6, the positive electrode cracked at the time of winding and the battery was not able to be completed. It is considered that this is because the content of the positive electrode binder is high and thus the flexibility of the positive electrode active material layer is decreased.

Hence, it is possible to achieve both heating safety before and after charge and discharge cycles and cycle characteristics by combining a laminate type electrode body configuration with a positive electrode binder having a melting point of 166° C. or less. In order to particularly improve the cycle characteristics, it is preferable to set the binder content to 4.0% or less.

The embodiments of the present technology have been specifically described above, but the present technology is not limited to the above-described embodiments, and various modifications can be made based on the technical idea of the present technology.

For example, the configurations, methods, steps, shapes, materials, numerical values and the like mentioned in the above-described embodiments are merely examples, and configurations, methods, steps, shapes, materials, numerical values and the like different from these may be used, if necessary.

The configurations, methods, steps, shapes, materials, numerical values and the like of the above-described embodiments can be combined with each other without departing from the gist of the present technology.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a plurality of positive electrodes having a positive electrode active material layer including a fluorine-based binder having a melting point of 166° C. or less;
a plurality of negative electrodes having a negative electrode active material layer; and
an electrolyte,
wherein the positive electrode active material layer and the negative electrode active material layer face each other, and
wherein an edge of the positive electrode active material layer is located inside an edge of the negative electrode active material layer.

2. The secondary battery according to claim 1, wherein the plurality of positive electrodes and the plurality of negative electrodes are alternately arranged with each other.

3. The secondary battery according to claim 1, wherein a content of the fluorine-based binder in the positive electrode active material layer is fr©m 0.5% by mass to 4.0% by mass.

4. The secondary battery according to claim 1 further comprising a separator, wherein the separator is provided between the positive electrodes and the negative electrodes.

5. The secondary battery according to claim 4, wherein the separator includes a porous film.

6. The secondary battery according to claim 1, wherein the positive electrodes further include a positive electrode current collector.

7. The secondary battery according to claim 6, wherein the positive electrode current collector includes at least one of aluminum foil, nickel foil and a stainless steel foil.

8. The secondary battery according to claim 1, wherein the fluorine-based binder includes polyvinylidene fluoride.

9. The secondary battery according to claim 1, wherein the negative electrode active material layer is larger than the positive electrode active material layer.

10. A battery pack comprising:
the secondary battery according to claim 1; and
a charge and discharge circuit,

11. An electronic device comprising:
the secondary battery according to claim 1, and
an electronic circuit connected to the secondary battery.
